(19) United States
(12) Patent Application Publication
(10) Pub. No.: US 2023/0409664 A1
(43) Pub. Date: Dec. 21, 2023

(54) DATA ANALYSIS DEVICE, DATA ANALYSIS METHOD, AND PROGRAM

(71) Applicant: Panasonic Intellectual Property Management Co., Ltd., Osaka (JP)

(72) Inventors: SHINGO YAMAGUCHI, Kyoto (JP); MIRAI SHIMAGUCHI, Osaka (JP); YUICHIRO SADANAGA, Osaka (JP); NOBUO HARA, Osaka (JP)

(21) Appl. No.: 18/460,647

(22) Filed: Sep. 4, 2023

Related U.S. Application Data
(63) Continuation of application No. PCT/JP2022/008121, filed on Feb. 28, 2022.

(30) Foreign Application Priority Data
Mar. 15, 2021 (JP) 2021-041793

(51) Int. Cl. G06F 17/11

(52) U.S. Cl. CPC G06F 17/11

(57) ABSTRACT

Data analysis device 1 includes: a difference value calculator that calculates, in data section (i, i+1) in which ith data at a predetermined date and time among the plurality of pieces of data is used as a start point value and (i+1)th data at a date and time after the predetermined date and time is used as an end point value, explanatory variable difference value ΔX that is a difference between start point value X(i) of explanatory variable X included in the ith data and end point value X(i+1) of explanatory variable X included in the (i+1)th data, and target variable difference value ΔY that is a difference between start point value Y(i) of target variable Y included in the ith data and end point value Y(i+1) of target variable Y included in the (i+1) data; and a difference model derivation unit that derives difference model M indicating a relationship between explanatory variable difference value ΔX and target variable difference value ΔY based on a plurality of the explanatory variable difference values ΔX and a plurality of the target variable difference values ΔY.

### TECHNICAL FIELD

The present disclosure relates to a data analysis device and a data analysis method which analyze a plurality of pieces of data, and a program for executing the data analysis method.

### BACKGROUND ART

There has hitherto been known a data analysis device that analyzes a plurality of pieces of data. As an example of the device, PTL 1 describes a data analysis device that performs multiple regression analysis on a plurality of pieces of time-series data and predicts a future value using the analysis result. Specifically, in the data analysis device of PTL 1, for an explanatory variable of actual data to which order information such as a time series has been given, a term obtained by performing primary and secondary differentiation of the feature of data fluctuation according to the order information such as the time series with time and order is given as a new explanatory variable, whereby the multiple regression model of the target variable of the actual data, to which the order information such as the time series has been given, is calculated and a target variable at an arbitrary date and in arbitrary order is predicted.

### CITATION LIST

### Patent Literature

PTL 1: Unexamined Japanese Patent Publication No. 2016-031714

### SUMMARY OF THE INVENTION

A data analysis device according to one aspect of the present disclosure is a data analysis device that analyzes a plurality of pieces of data including one or more types of explanatory variables and one type of target variable, the data analysis device including: a data acquisition unit that acquires the plurality of pieces of data; a difference value calculator that calculates an explanatory variable difference and a target variable difference in a data section, the data section being a section in which ith data at a predetermined date and time among the plurality of pieces of data is used as a start point value and (i+1)th data at a date and time after the predetermined date and time is used as an end point value, the explanatory variable difference value being a difference between the start point value of the explanatory variable included in the ith data and the end point value of the explanatory variable included in the (i+1)th data, the target variable difference value being a difference between the start point value of the target variable included in the ith data and the end point value of the target variable included in the (i+1) data, where i is an integer of one or more; and a difference model derivation unit that derives a difference model indicating a relationship between the explanatory variable difference value and the target variable difference value based on a plurality of the explanatory variable difference values and a plurality of the target variable difference values.

A data analysis method according to one aspect of the present disclosure is a data analysis method for analyzing a plurality of pieces of data including one or more types of explanatory variables and one type of target variable, the data analysis method including: acquiring the plurality of pieces of data; calculating an explanatory variable difference and a target variable difference in a data section, the data section being a section in which ith data at a predetermined date and time among the plurality of pieces of data is used as a start point value and (i+1)th data at a date and time after the predetermined date and time is used as an end point value, the explanatory variable difference value being a difference between the start point value of the explanatory variable included in the ith data and the end point value of the explanatory variable included in the (i+1)th data, the target variable difference value being a difference between the start point value of the target variable included in the ith data and the end point value of the target variable included in the (i+1) data, where i is an integer of one or more; deriving a difference model indicating a relationship between the explanatory variable difference value and the target variable difference value based on a plurality of the explanatory variable difference values and a plurality of the target variable difference values; and predicting at least one of the end point value of the explanatory variable and the end point value of the target variable in the data in a future by using the difference model.

Note that those comprehensive, specific aspects may be realized by a system, a method, an integrated circuit, a computer program, or a computer-readable recording medium such as a compact disc read-only memory (CD-ROM), or may be realized by any combination of the system, the method, the integrated circuit, the computer program, and the recording medium.

### BRIEF DESCRIPTION OF THE DRAWINGS

FIG. 1 is a diagram showing an example of a data analysis system in an exemplary embodiment.

FIG. 2 is a diagram showing a configuration of a data analysis device in the exemplary embodiment.

FIG. 3 is a diagram showing an example of a data set in the exemplary embodiment.

FIG. 4 is a diagram showing an example of an explanatory variable and a target variable selected from a data set in the exemplary embodiment.

FIG. 5 is a block diagram showing a functional configuration of the data analysis device according to a first exemplary embodiment.

FIG. 6 is a diagram showing an example of a plurality of pieces of data acquired by the data analysis device according to the first exemplary embodiment.

FIG. 7 is a diagram showing an example of a plurality of data sections set for a plurality of pieces of data.

FIG. 8 is a diagram showing an explanatory variable difference value and a target variable difference value in each data section.

FIG. 9 is a diagram showing a relationship between an explanatory variable difference value and a target variable difference value in the first exemplary embodiment.

FIG. 10 is a diagram schematically showing an effect of the data analysis device according to the first exemplary embodiment.

FIG. 11 is a flowchart showing an example of a data analysis method according to the first exemplary embodiment.

FIG. 12 is a flowchart showing another example of the data analysis method according to the first exemplary embodiment.

FIG. 13 is a block diagram showing a functional configuration of a data analysis device according to a second exemplary embodiment.

FIG. 14 is a diagram showing an example of a plurality of pieces of data acquired by the data analysis device according to the second exemplary embodiment.

FIG. 15 is a diagram showing an example of data sections set for a plurality of pieces of data.

FIG. 16 is a diagram showing an explanatory variable difference value and a target variable difference value in each data section.

FIG. 17 is a diagram showing a relationship between an explanatory variable difference value and a target variable difference value in the second exemplary embodiment.

FIG. 18 is a flowchart showing an example of a data analysis method according to the second exemplary embodiment.

FIG. 19 is a flowchart showing another example of the data analysis method according to the second exemplary embodiment.

FIG. 20 is an example in which an explanatory variable difference value and a target variable difference value are obtained with respect to the data set of FIG. 3.

FIG. 21 is an example in which an explanatory variable difference value and a target variable difference value are obtained using standard values with respect to the data set of FIG. 3.

FIG. 22 is a diagram showing another example of a plurality of data sections set for a plurality of pieces of data.

### DESCRIPTION OF EMBODIMENT

In the analysis device described in PTL 1, for example, when there is an uncertain factor that affects the target variable in the actual data, it is difficult to analyze a plurality of pieces of data with high accuracy. It is thus difficult to accurately predict a future value.

The present disclosure has been made to solve the above problems, and an object of the present disclosure is to provide a data analysis device and the like capable of accurately analyzing a plurality of pieces of data.

Exemplary embodiments and the like will be described below with reference to the drawings. Each exemplary embodiment to be described below provides a comprehensive or specific example. Numerical values, shapes, materials, constituent elements, disposition positions and connection modes of the constituent elements, steps, order of the steps, and the like shown in the following exemplary embodiment and the like are merely examples, and therefore are not intended to limit the present disclosure. Of the components in each of the following exemplary embodiments, components that are not recited in the independent claims will be described as optional components.

Each drawing is schematically illustrated and is not strictly accurate. In the drawings, substantially the same components are denoted by the same reference numerals, and duplicate description may be omitted or simplified. Even when the same object is shown in the drawings, the scale may have been changed for convenience.

### First Exemplary Embodiment

[Hardware Configuration]

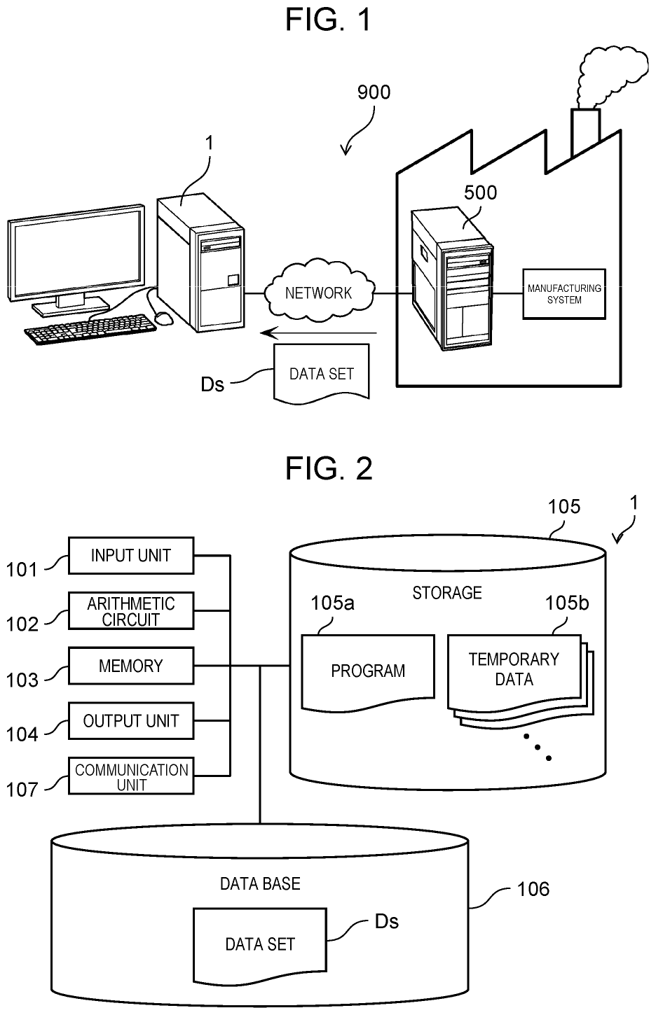

FIG. 1 is a diagram showing an example of a data analysis system in the present exemplary embodiment.

Data analysis system 900 in the present exemplary embodiment includes data analysis device 1 and manufacturing management device 500.

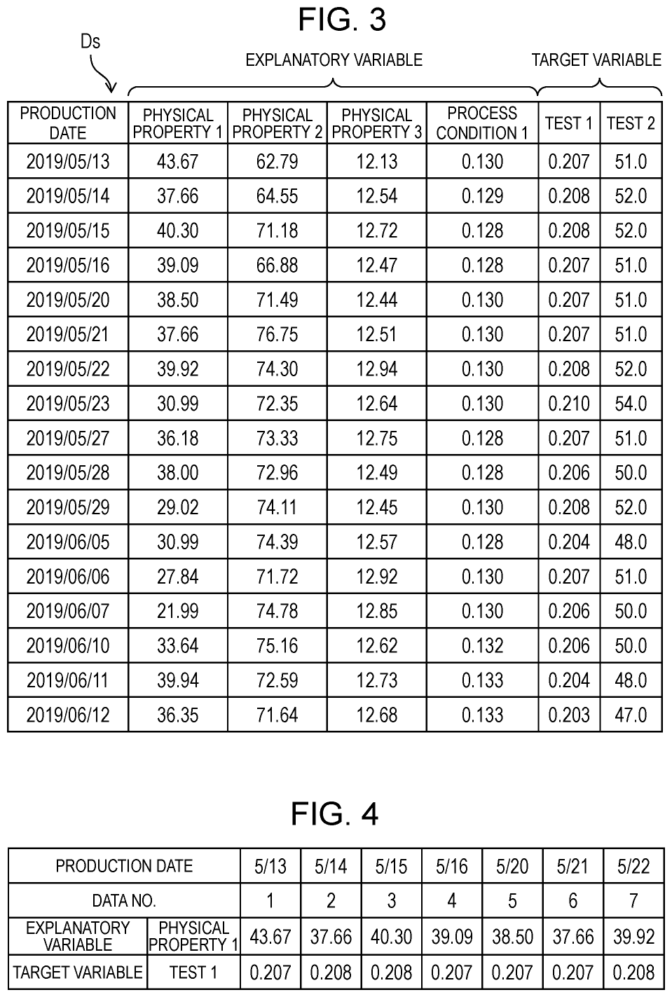

Manufacturing management device 500 is, for example, a device that is installed in a manufacturing factory and manages a manufacturing system for manufacturing a product. Manufacturing management device 500 transmits data set Ds obtained by the manufacturing system to data analysis device 1 via a network such as the Internet. Note that details of data set Ds will be described later with reference to FIGS. 3 and 4.

Data analysis device 1 includes a personal computer and the like and receives data set Ds from manufacturing management device 500. Then, data analysis device 1 in the present exemplary embodiment generates a plurality of models each indicating a relationship between the data of an explanatory variable and the data of a target variable based on data set Ds.

FIG. 2 is a view showing a configuration of data analysis device 1 in the present exemplary embodiment.

Data analysis device 1 includes input unit 101, arithmetic circuit 102, memory 103, output unit 104, storage 105, database 106, and communication unit 107.

Communication unit 107 communicates with a device outside data analysis device 1. The communication may be wired communication or wireless communication. The wireless communication method may be Wi-Fi (registered trademark), Bluetooth (registered trademark), or ZigBee, or may be other methods. For example, communication unit 107 communicates with manufacturing management device 500 and receives data set Ds from manufacturing management device 500.

Input unit 101 has a function as a human machine interface (HMI) that receives an input operation by the user and includes, for example, a keyboard, a mouse, a touch sensor, a touch pad, and the like.

Output unit 104 includes a display that displays an image, characters, or the like, and the display is, for example, a liquid crystal display, a plasma display, an organic electro-luminescence (EL) display, or the like. Note that output unit 104 may include a printer that prints an image, characters, or the like and may have a function of storing data, output from arithmetic circuit 102, in a file format in storage 105.

Storage 105 stores program (i.e., computer program) 105a in which each command to arithmetic circuit 102 is described. Further, each piece of temporary data 105b temporarily generated by the processing of arithmetic circuit 102 may be stored in storage 105. Note that such storage 105 is a nonvolatile recording medium and is, for example, a magnetic storage device such as a hard disk, an optical disk, a semiconductor memory, or the like. Note that program 105a is provided to data analysis device 1 via, for example, a removable medium or a network and is stored in storage 105. The removable medium is, for example, a compact disc read only memory (CD-ROM), a flash memory, or the like. Therefore, communication unit 107 may include an interface that reads program 105a of the removable medium.

Program 105a read and developed by arithmetic circuit 102 is temporarily stored into memory 103. Such memory 103 is, for example, a volatile random access memory (RAM).

Arithmetic circuit 102 is a circuit that executes program 105a expanded in memory 103 and is, for example, a central processing unit (CPU), a graphics processing unit (GPU), or the like. Arithmetic circuit 102 may use each piece of temporary data 105b stored in storage 105 when executing program 105a.

Similarly to storage 105, database 106 is a nonvolatile recording medium and is, for example, a magnetic storage device such as a hard disk, an optical disk, a semiconductor memory, or the like. For example, arithmetic circuit 102 acquires data set Ds from manufacturing management device 500 via the network and communication unit 107 and stores data set Ds in database 106.

In the present exemplary embodiment, storage 105 and database 106 are different recording media, but storage 105 and database 106 may be configured as one recording medium including the storage and the database.

[Data Set]

FIG. 3 is a diagram showing an example of data set Ds in the present exemplary embodiment.

Data set Ds is a raw data set transmitted from manufacturing management device 500 and is, for example, a structured data set made up of a plurality of pieces of manufacturing data indicating physical properties in a manufacturing process of the manufacturing system described above, process conditions, quality of a product manufactured by the manufacturing process, and the like. As shown in FIG. 3, such data set Ds indicates respective variable names of a plurality of variables and data of the variables. Note that the data may be any data so long as the data indicates at least one of a character and a number. The respective variable names of the plurality of variables are arranged in the first row of data set Ds, and the respective pieces of data of the plurality of variables are arranged in each of the second and subsequent rows of data set Ds.

Note that a production date is indicated in the leftmost column of data set Ds. Here, a description will be given of an example in which a manufacturing process is set for each production date, that is, a description will be given of an example in which a manufacturing process is set once, and production is performed in the same manufacturing process for one day.

As shown in FIG. 3, in the first row of data set Ds, physical property 1, physical property 2, physical property 3, process condition 1, test 1, and test 2, which are variable names, are arranged. Physical property 1, physical property 2, and physical property 3 are appropriately selected from, for example, a viscosity, a particle size, a solid content ratio, and the like. Process condition 1 is appropriately selected from, for example, a flow rate, pressure, and the like. Test 1 and test 2 are test items of a product or a half-finished product when manufactured under Physical Property 1, Physical Property 2, Physical Property 3, and Process Condition 1. Test 1 and test 2 are appropriately selected from, for example, a coating weight, a film thickness, a coating area, and the like. The second and subsequent rows of data set Ds include data of variables identified by these variable names.

In the present exemplary embodiment, physical property 1, physical property 2, physical property 3, and process condition 1 shown in FIG. 3 are explanatory variables, and test 1 and test 2 are target variables. In this example, four types of explanatory variables are shown, and two types of target variables are shown.

FIG. 4 is a diagram showing an example of an explanatory variable and a target variable selected from data set Ds. FIG. 4 shows a state where physical property 1 and test 1 are selected from data set Ds shown in FIG. 3 and arranged for each production date. In FIG. 4, data numbers are assigned corresponding to the order of the production date. In the drawing, physical property 1 is selected as an explanatory variable, and test 1 is selected as a target variable.

Note that the method of selecting the explanatory variable and the target variable is not limited thereto. For example, from data set Ds, physical property 2 may be selected as an explanatory variable, and test 2 may be selected as a target variable. Physical property 1 and physical property 2 may be selected as explanatory variables, and test 1 may be selected as a target variable. Physical property 1, physical property 2, and physical property 3 may be selected as explanatory variables, and test 1 may be selected as a target variable. That is, two or more types of explanatory variables and one type of target variable may be selected.

In FIG. 4, the daily production date is selected, but the method of selecting the production date is not limited thereto. For example, 5/13 and 5/15 may be selected every other day from 5/13 to 5/16 of data set Ds, 5/20 and 5/22 may be selected every other day from 5/20 to 5/23, 5/27 and 5/29 may be selected every other day from 5/27 to 5/29, and 6/5 and 6/7 may be selected every other day from 6/5 to 6/7.

The data analysis device of the present exemplary embodiment performs data analysis on data set Ds as exemplified above. In order to facilitate the understanding of the invention, the explanatory variable and the target variable described above will be further simplified and described below.

[Configuration of Data Analysis Device]

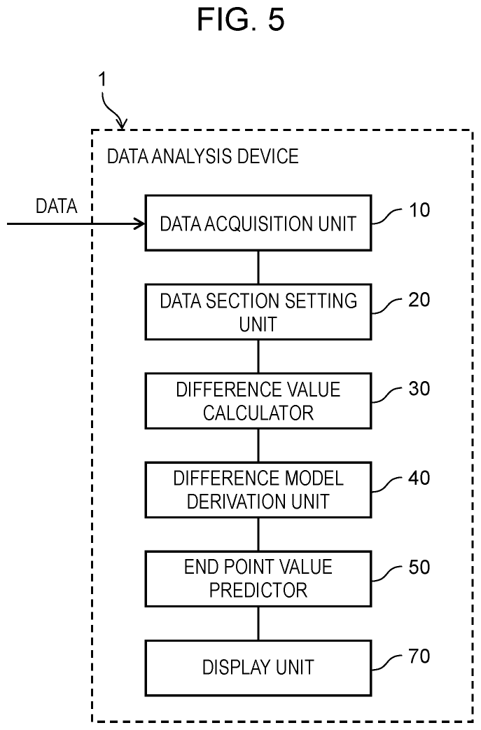

A configuration of a data analysis device according to the first exemplary embodiment will be described with reference to FIGS. 5 to 10.

FIG. 5 is a block diagram showing a functional configuration of data analysis device 1 according to the first exemplary embodiment.

As shown in FIG. 5, data analysis device 1 includes data acquisition unit 10, data section setting unit 20, difference value calculator 30, and difference model derivation unit 40. Further, data analysis device 1 includes end point value predictor 50 and output unit 104. A functional configuration of data analysis device 1 is realized by executing a program stored in storage 105.

Data acquisition unit 10 acquires a plurality of pieces of data from the outside. For example, data acquisition unit 10 acquires a plurality of pieces of data by an operation input by a user who uses data analysis device 1, a data input by an external device, or the like.

Each of the plurality of pieces of data includes one or more types of explanatory variables X that are data to be a cause and one type of target variable Y that is data to be a result. Each of explanatory variable X and target variable Y is represented by a physical quantity of the base unit of the International System of Units (SI base unit), such as a length, a mass, a current, a temperature, or a time. Note that explanatory variable X may include a person, a tool, a place, or the like that cannot be expressed by the physical quantity described above. The plurality of pieces of data of the present exemplary embodiment are indicated in time series such as hour, minute, day, week, and month. The time-series data indicated in time series is data indicating a temporal change of a physical quantity and the like, and the physical quantity and the time are associated with each other. The plurality of pieces of data indicated in time series may be pieces of data arranged at equal time intervals or may be pieces of data arranged at different time intervals.

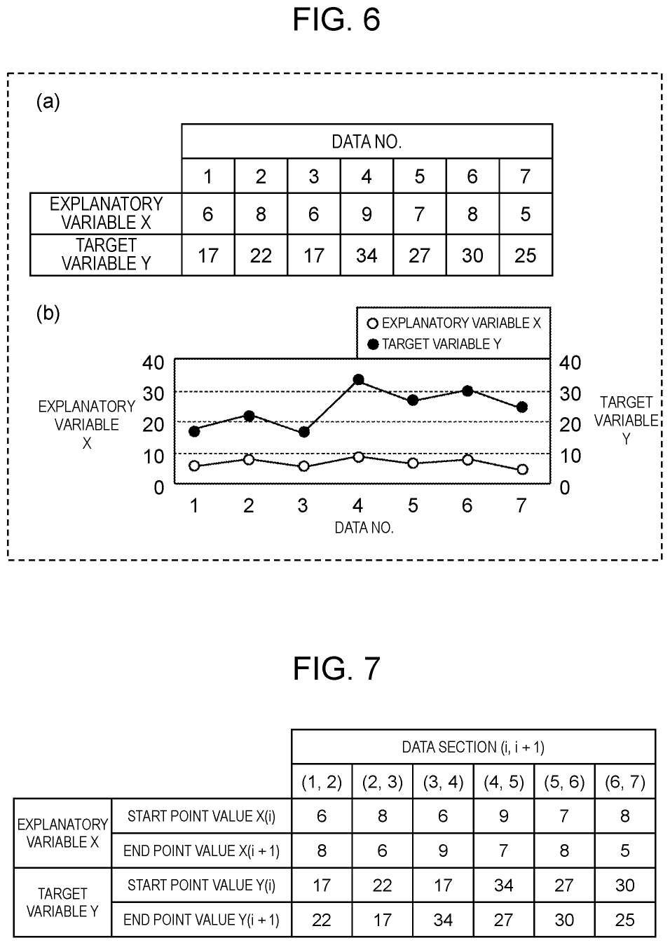

FIG. 6 is a diagram showing an example of a plurality of pieces of data acquired by data analysis device 1. Part (a) of FIG. 6 shows a plurality of pieces of data in a table, and part (b) of FIG. 6 shows a plurality of pieces of data in a graph.

FIG. 6 shows a state where explanatory variable X and target variable Y included in each piece of data are organized in time series. Although FIG. 6 shows simplified data, explanatory variable X in FIG. 6 may be input data (e.g., manufacturing condition data) input in a manufacturing process, and target variable Y may be output data (e.g., test data) obtained based on an intermediate product, a manufactured product, or the like manufactured in the manufacturing process. Each piece of data includes an uncertain element that affects target variable Y, that is, an element that cannot be separated although affecting target variable Y. The uncertain element that affects target variable Y is, for example, noise or disturbance.

Hereinafter, a case where each piece of data includes one explanatory variable X and one target variable Y will be described as an example. The plurality of pieces of data acquired by data acquisition unit 10 is stored into memory 103 of data analysis device 1 and output to data section setting unit 20.

Data section setting unit 20 sets a plurality of data sections for the plurality of pieces of data output from data acquisition unit 10. The data section is a section of two pieces of data having different date and time among a plurality of pieces of data in each which a physical quantity and time are associated, and the unit of the data section is, for example, second, minute, hour, day, week, or the like. In each data section, there are a start point value that is data at the start of the data section and an end point value that is data at the end of the data section.

FIG. 7 is a diagram showing an example of a plurality of data sections (i, i+1) set for a plurality of pieces of data. Note that i is a number (order) corresponding to each piece of data when the plurality of pieces of data are arranged in time series. i is an integer of one or more.

As shown in FIG. 7, in data section (i, i+1), ith data at a predetermined date and time is the start point value, and (i+1)th data at a date and time after the predetermined date and time is the end point value. Each of the ith data and the (i+1)th data includes explanatory variable X and target variable Y. For example, in a first data section (1, 2) in FIG. 7, each of explanatory variable X(1)=6 and target variable Y(1)=17 is the start point value, and each of explanatory variable X(2)=8 and target variable Y(2)=22 is the end point value.

In the example shown in FIG. 7, the end point value in one data section (i, i+1) is the start point value in the next data section (i, i+1). Specifically, explanatory variable X(2)=8 is the end point value in the data section (1, 2), and explanatory variable X(2)=8 is the start point value in a data section (2, 3). As described above, data section setting unit sets each data section such that two data sections adjacent in time series have common data. Data section setting unit 20 may set each data section such that a plurality of data sections are connected as a whole.

Note that data section setting unit 20 does not necessarily set data sections for pieces of data arranged in time series. For example, data section setting unit 20 may set data sections for pieces of data arranged in time series by skipping some pieces of data instead of following the order. The data section is desirably set to have a constant width in consideration of, for example, a period during which the manufacturing system is operating. How to set the data section may be determined by default or may be changeable by human operation input. Data section (i, i+1) set by data section setting unit 20 is stored into memory 103 and output to difference value calculator 30 together with the plurality of pieces of data.

Difference value calculator 30 calculates a difference value related to explanatory variable X and a difference value related to target variable Y for each data section (i, i+1) set by data section setting unit 20. Specifically, difference value calculator 30 calculates explanatory variable difference value ΔX that is a difference between start point value X(i) of explanatory variable X included in the ith data and end point value X(i+1) of explanatory variable X included in the (i+1)th data (ΔX=X(i+1)−X(i)). Difference value calculator 30 calculates target variable difference value ΔY that is a difference between start point value Y(i) of target variable Y included in the ith data and end point value Y(i+1) of target variable Y included in the (i+1)th data (ΔY=Y(i+1)−Y(i)). The difference here is a value obtained by subtracting the start point value from the end point value.

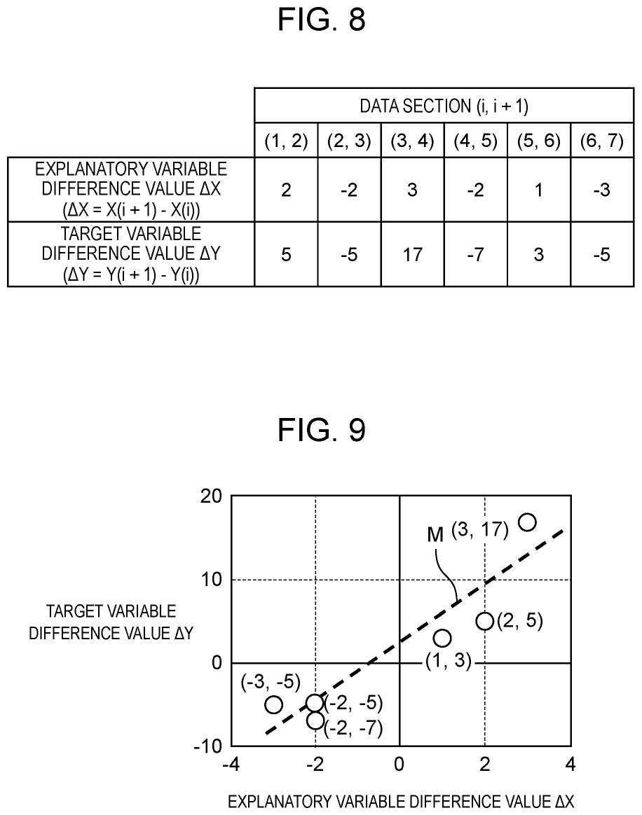

FIG. 8 is a diagram showing explanatory variable difference value ΔX and target variable difference value ΔY in each data section (i, i+1). For example, FIG. 8 shows that explanatory variable difference value ΔX in the data section (1, 2) is 2, and target variable difference value ΔY is 5. The plurality of explanatory variable difference values ΔX and target variable difference value ΔY calculated by difference value calculator 30 are output to difference model derivation unit 40.

Difference model derivation unit 40 derives difference model M indicating a relationship between explanatory variable difference value ΔX and target variable difference value ΔY based on the plurality of explanatory variable difference values ΔX and target variable difference value ΔY.

FIG. 9 is a diagram showing a relationship between explanatory variable difference value ΔX and target variable difference value ΔY. In FIG. 9, a plurality of explanatory variable difference values ΔX and target variable difference value ΔY calculated by difference value calculator 30 are plotted. In FIG. 9, difference model M indicating the relationship between the plurality of explanatory variable difference values ΔX and target variable difference value ΔY is indicated by a thick broken line. Difference model M shown in FIG. 9 is defined by, for example, (Equation 1) below. Note that k is the number of explanatory variables X.

$$\begin{matrix}[ Mathematical Expression 1 ] & \\ Δ Y = {β}_{10} + {\sum }_{k = 1}^{k} {β}_{1 k} Δ {X}_{k} & ( Equation 1 )\end{matrix}$$

In (Equation 1), by estimating the multiple regression coefficients β₁₀, β₁ₖ using target variable difference value ΔY and explanatory variable difference value ΔX, one regression model equation (equation of difference model M) for target variable difference value ΔY and explanatory variable difference value ΔX can be obtained.

In the above description, target variable difference value ΔY has been defined by the linear expression of explanatory variable difference value ΔX as difference model M. However, target variable difference value ΔY may be defined by a product-sum term of explanatory variable difference value ΔX, and difference model M may be defined by (Equation 2) below.

$$\begin{matrix}[ Mathematical Expression 2 ] & \\ Δ Y = {β}_{10} + {\sum }_{k = 1}^{k} {β}_{1 k} Δ {X}_{k} + {\sum }_{k = 1}^{k} {\sum }_{m = 1}^{m} {γ}_{1 k} Δ {X}_{k} Δ {X}_{m} & ( Equation 2 )\end{matrix}$$

In addition, target variable difference value ΔY can be defined by an arbitrary polynomial of explanatory variable difference value ΔX, and difference model M can be defined by (Equation 3) below. Note that the relationship among degrees r, p, q of the polynomial is r>p, q, . . . >1. The polynomial represents a general expression including a logarithm, an index, a trigonometric function, and the like.

$$\begin{matrix}[ Mathematical Expression 3 ] & \\ Δ Y = {β}_{0} + {\sum }_{k = 1}^{k} {β}_{k} Δ {X}_{k} + {\sum }_{k = 1}^{k} {\sum }_{m = 1}^{m} {γ}_{k} Δ {X}_{k} Δ {X}_{m} + … + {\sum }_{k = 1}^{k} {δ}_{k} Δ {X}_{m}^{r} + {\sum }_{k = 1}^{k} {\sum }_{m = 1}^{m} {n}_{k} Δ {X}_{m}^{p} Δ {X}_{m}^{q} … + & ( Equation 3 )\end{matrix}$$

Difference model M derived by Difference model derivation unit 40 is stored into memory 103 and output to end point value predictor 50.

End point value predictor 50 predicts at least one of end point value X(i+1) of explanatory variable X and end point value Y(i+1) of target variable Y in the future data by using difference model M.

First, a description will be given of an example in which end point value predictor 50 predicts end point value X(i+1) of explanatory variable X in the future data. Predicting end point value X(i+1) of explanatory variable X that is an input is useful for bringing output data, obtained based on an intermediate product, a manufactured product, or the like manufactured in the manufacturing process, close to target value T (not shown) that is output data originally desired to be obtained. The prediction makes it possible to derive a manufacturing condition under which the test data of the intermediate product or the manufactured product becomes target value T (desired value).

For example, end point value predictor 50 inputs respective end point values X(i+1), Y(i+1) of explanatory variable X and target variable Y included in the past data into difference model M as respective start point values X(i), Y(i) of explanatory variable X and target variable Y in the future data. Then, end point value predictor 50 gives target value T of target variable Y in the future data to difference model M to obtain end point value X(i+1) of explanatory variable X in the future data. More specifically, end point value predictor 50 obtains end point value X(i+1) of explanatory variable X in the future data in a case where end point value Y(i+1) of target variable Y in the future data is a value closet to target value T in difference model M.

In this case, end point value Y(i+1) of target variable Y closest to target value T may be obtained, and thereafter, difference model M may be back-calculated to obtain end point value X(i+1) of explanatory variable X. End point value Y(i+1) of target variable Y closest to target value T can be determined by calculating the distance between target value T and end point value Y(i+1) of target variable Y. End point value X(i+1) of explanatory variable X when end point value Y(i+1) of target variable Y is closest to target value T may be obtained while explanatory variable X is varied in difference model M. When end point value Y(i+1) of target variable Y is closest to target value T can be determined by calculating the distance between target value T and end point value Y(i+1) of target variable Y. Note that target value T is a value set by the user and stored in storage 105.

Next, a description will be given of an example in which end point value predictor predicts end point value Y(i+1) of target variable Y in the future data. Predicting end point value Y(i+1) of target variable Y that is an output is useful for grasping the output with respect to the input.

For example, end point value predictor 50 inputs respective end point values X(i+1), Y(i+1) of explanatory variable X and target variable Y included in the past data into difference model M as respective start point values X(i), Y(i) of explanatory variable X and target variable Y in the future data. Then, end point value predictor 50 inputs end point value X(i+1) of explanatory variable X in the future data into difference model M to obtain end point value Y(i+1) of target variable Y in the future data.

End point value X(i+1) of explanatory variable X or end point value Y(i+1) of target variable Y predicted by end point value predictor 50 is stored into memory 103. End point value X(i+1) of explanatory variable X or end point value Y(i+1) of target variable Y may be output to output unit 104 and displayed on output unit 104.

Output unit 104 is, for example, a display device such as a liquid crystal panel and displays end point value X(i+1) of explanatory variable X or end point value Y(i+1) of target variable Y output from end point value predictor 50. Note that output unit 104 may display a plurality of pieces of data, data sections, difference model M, and target value T.

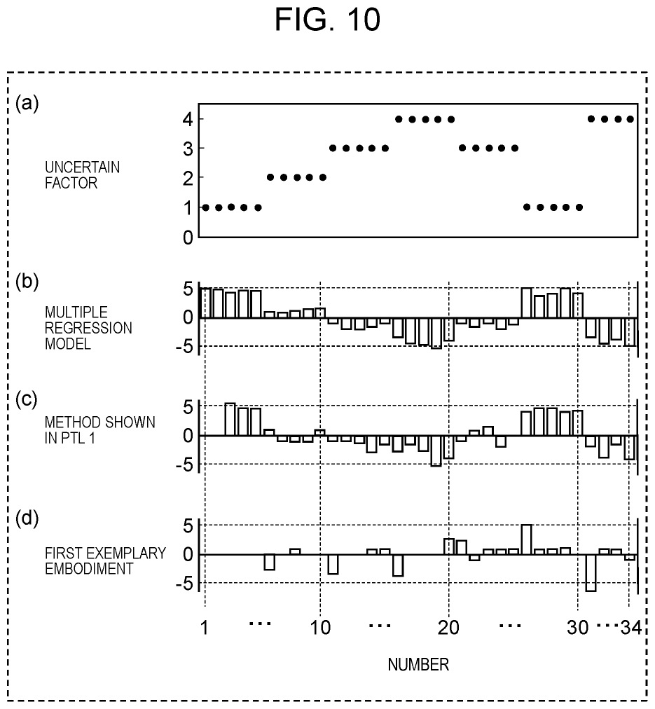

FIG. 10 is a diagram schematically showing an effect of data analysis device 1.

Part (a) of FIG. 10 shows uncertain factors included in a plurality of pieces of data. Part (b) of FIG. 10 shows the difference between the end point value of target variable Y predicted by a general multiple regression model and target value T. Part (c) of FIG. 10 shows the difference between the end point value of target variable Y predicted by the method described in PTL 1 and target value T. Part (d) of FIG. 10 shows the difference between end point value Y(i+1) of target variable Y predicted according to the present exemplary embodiment and target value T. In parts (b) to (d) of FIG. 10, the horizontal axis represents the number given in the order of time series corresponding to the time-series data, and the vertical axis represents the difference between the end point value and target value T.

As shown in the drawing, in data analysis device 1 according to the present exemplary embodiment, the difference between end point value Y(i+1) of target variable Y and target value T is smaller than those obtained by the general multiple regression model and the method shown in PTL 1. Unlike the general multiple regression model and the method shown in PTL 1, data analysis device 1 creates difference model M based on the difference between start point value X(i) and end point value X(i+1) of explanatory variable X and the difference between start point value Y(i) and end point value Y(i+1) of target variable Y. By generating the model based on the difference between the start point value and the end point value in this manner, at least some of uncertainty factors included in the data can be canceled. Hence it is possible to derive difference model M in a state where the influence of the uncertain factors has been reduced. As a result, a plurality of pieces of data can be analyzed with high accuracy.

The use of difference model M enables accurate prediction of end point value X(i+1) of explanatory variable X most suitable for bringing end point value Y(i+1) of target variable Y close to target value T. Difference model M enables accurate prediction of end point value Y(i+1) of target variable Y that is an output for a case where end point value X(i+1) of explanatory variable X is input. [Example of data analysis method]

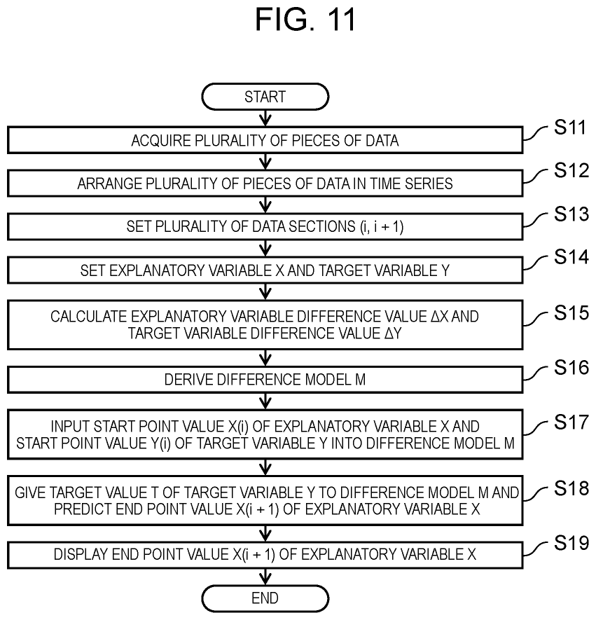

An example of a data analysis method according to the first exemplary embodiment will be described with reference to FIG. 11. In this example, a description will be given of an example of predicting end point value X(i+1) of explanatory variable X most suitable for bringing end point value Y(i+1) of target variable Y close to target value T.

FIG. 11 is a flowchart showing an example of the data analysis method according to the first exemplary embodiment.

First, data acquisition unit 10 of data analysis device 1 acquires a plurality of pieces of data as shown in FIG. 6 (step S11).

Next, data section setting unit 20 organizes the plurality of pieces of data in time series (step S12). Specifically, data section setting unit 20 arranges the plurality of pieces of data in ascending order of time. For example, data numbers are sequentially given to a plurality of pieces of data organized in time series instead of dates and times. At the time of extracting some pieces of data from the plurality of pieces of data, it is desirable to extract the data such that the intervals of the date and time are equal. Data section setting unit 20 sets a plurality of data sections (i, i+1) as shown in FIG. 7 for the plurality of pieces of data organized in time series (step S13).

In a case where data organized in time series is input in advance into data acquisition unit 10 or data section setting unit 20, step S12 may be omitted. When difference value calculator 30 described below has the function of data section setting unit steps S12 and S13 may be executed by difference value calculator 30.

Difference value calculator 30 sets explanatory variable X and target variable Y for the plurality of pieces of data based on the setting condition determined by the user (step S14). Note that explanatory variable X and target variable Y may be set in advance in the plurality of pieces of data input to data acquisition unit 10 or may be set by data section setting unit 20.

Next, in each data section (i, i+1), difference value calculator 30 calculates explanatory variable difference value ΔX that is a difference between start point value X(i) of explanatory variable X included in the ith data and end point value X(i+1) of explanatory variable X included in the (i+1)th data. In each data section (i, i+1), difference value calculator 30 calculates target variable difference value ΔY that is a difference between start point value Y(i) of target variable Y included in the ith data and end point value Y(i+1) of target variable Y included in the (i+1)th data (step S15. FIG. 8)

Next, difference model derivation unit 40 derives difference model M indicating a relationship between explanatory variable difference value ΔX and target variable difference value ΔY based on the plurality of explanatory variable difference values ΔX and target variable difference value ΔY (step S16). The definition of difference model M is as described with reference to FIG. 9.

Next, end point value predictor 50 inputs respective end point values X(i+1), Y(i+1) of explanatory variable X and target variable Y included in the past data into difference model M as respective start point values X(i), Y(i) of explanatory variable X and target variable Y in the future data (step S17). Then, end point value predictor 50 gives target value T of target variable Y in the future data to difference model M to obtain end point value X(i+1) of explanatory variable X in the future data (step S18). More specifically, end point value predictor 50 obtains end point value X(i+1) of explanatory variable X in the future data in a case where end point value Y(i+1) of target variable Y in the future data is a value closet to target value T in difference model M.

Output unit 104 displays end point value X(i+1) of explanatory variable X predicted by end point value predictor 50 (step S19). By executing these steps S11 to S19, a plurality of pieces of data can be analyzed with high accuracy.

### Another Example of Data Analysis Method

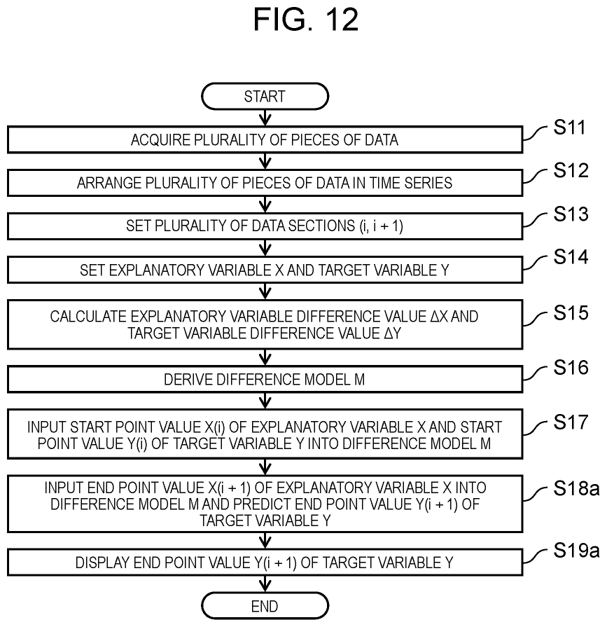

Another example of the data analysis method according to the first exemplary embodiment will be described with reference to FIG. 12. In another example, a description will be given of an example of predicting end point value Y(i+1) of target variable Y that is an output when end point value X(i+1) of predetermined explanatory variable X is input.

FIG. 12 is a flowchart showing another example of the data analysis method according to the first exemplary embodiment. Steps S11 to S16 are the same as the data analysis method in FIG. 11, and the description thereof will be omitted.

In this example, end point value predictor 50 inputs respective end point values X(i+1), Y(i+1) of explanatory variable X and target variable Y included in the past data into difference model M as respective start point values X(i), Y(i) of explanatory variable X and target variable Yin the future data (step S17). Then, end point value predictor 50 inputs end point value X(i+1) of explanatory variable X in the future data into difference model M to obtain end point value Y(i+1) of target variable Y in the future data (step S18a).

Output unit 104 displays end point value Y(i+1) of target variable Y predicted by end point value predictor 50 (step S19a). By executing these steps S11 to S19, a plurality of pieces of data can be analyzed with high accuracy.

### Effects and the Like

Data analysis device 1 according to the present exemplary embodiment is a device that analyzes a plurality of pieces of data including one or more types of explanatory variables X and one type of target variable Y, and includes data acquisition unit 10, difference value calculator 30, and difference model derivation unit 40. Data acquisition unit 10 acquires a plurality of pieces of data. In data section (i, i+1) in which the ith data at a predetermined date and time among the plurality of pieces of data is used as a start point value and the (i+1)th data at a date and time after the predetermined date and time is used as an end point value, difference value calculator 30 calculates explanatory variable difference value ΔX that is a difference between start point value X(i) of explanatory variable X included in the ith data and end point value X(i+1) of explanatory variable X included in the (i+1)th data, and target variable difference value ΔY that is a difference between start point value Y(i) of target variable Y included in the ith data and end point value Y(i+1) of target variable Y included in the (i+1)th data. Difference model derivation unit 40 derives difference model M indicating a relationship between explanatory variable difference value ΔX and target variable difference value ΔY based on the plurality of explanatory variable difference values ΔX and target variable difference value ΔY.

By generating difference model M based on explanatory variable difference value ΔX and target variable difference value ΔY in each data section (i, i+1) in this manner, at least some of the uncertain factors included in the data can be canceled. Hence it is possible to derive difference model M in a state where the uncertain factors have been reduced. As a result, a plurality of pieces of data can be analyzed with high accuracy.

Data analysis device 1 may further include data section setting unit 20 that sets data section (i, i+1) for the plurality of pieces of data acquired by data acquisition unit 10, and difference value calculator 30 may calculate explanatory variable difference value ΔX and target variable difference value ΔY for each data section (i, i+1) set by data section setting unit 20.

With this configuration, it is possible to appropriately set data section (i, i+1), and derive appropriate difference model M based on explanatory variable difference value ΔX and target variable difference value ΔY for each set data section (i, i+1). Thereby, a plurality of pieces of data can be analyzed with high accuracy.

Data analysis device 1 may further include end point value predictor 50 that predicts at least one of end point value X(i+1) of explanatory variable X and end point value Y(i+1) of target variable Y in the future data by using difference model M.

With this configuration, end point value X(i+1) of explanatory variable X or end point value Y(i+1) of target variable Y can be predicted with high accuracy by using difference model M in a state where the uncertainty factors have been reduced.

End point value predictor 50 may input respective end point values X(i+1), Y(i+1) of explanatory variable X and target variable Y included in the past data into difference model M as respective start point values X(i), Y(i) of explanatory variable X and target variable Y in the future data and gives target value T of target variable Y in the future data to difference model M to obtain end point value X(i+1) of explanatory variable X in the future data.

According to this, it is possible to accurately predict end point value X(i+1) of explanatory variable X suitable for bringing end point value Y(i+1) of target variable Y closer to target value T.

End point value predictor 50 obtains end point value X(i+1) of explanatory variable X in the future data in a case where end point value Y(i+1) of target variable Y in the future data is a value closet to target value T in difference model M.

According to this, it is possible to easily and accurately predict end point value X(i+1) of explanatory variable X.

End point value predictor 50 may input respective end point values X(i+1), Y(i+1) of explanatory variable X and target variable Y included in the past data into difference model M as respective start point values X(i), Y(i) of explanatory variable X and target variable Y in the future data and input end point value X(i+1) of explanatory variable X in the future data into difference model M to obtain end point value Y(i+1) of target variable Y in the future data.

According to this, it is possible to accurately predict end point value Y(i+1) of target variable Y corresponding to end point value X(i+1) of explanatory variable X.

Data analysis device 1 may further include output unit 104 that displays at least one of end point value X(i+1) of explanatory variable X and end point value Y(i+1) of target variable Y in the future data.

According to this, it is possible to notify the user of the information regarding end point value X(i+1) of explanatory variable X or end point value Y(i+1) of target variable Y by using output unit 104.

The data analysis method according to the present exemplary embodiment is a method of analyzing a plurality of pieces of data including one or more types of explanatory variables X and one type of target variable Y. This data analysis method includes the steps of: acquiring a plurality of pieces of data; calculating, in data section (i, i+1) in which ith (i is an integer of one or more) data at a predetermined date and time among the plurality of pieces of data is used as a start point value and (i+1)th data at a date and time after the predetermined date and time is used as an end point value, explanatory variable difference value ΔX that is a difference between start point value X(i) of explanatory variable X included in the ith data and end point value X(i+1) of explanatory variable X included in the (i+1)th data, and target variable difference value ΔY that is a difference between start point value Y(i) of target variable Y included in the ith data and end point value Y(i+1) of target variable Y included in the (i+1) data; deriving difference model M indicating a relationship between explanatory variable difference value ΔX and target variable difference value ΔY based on a plurality of the explanatory variable difference values ΔX and a plurality of the target variable difference values ΔY, and predicting at least one of end point value X(i+1) of explanatory variable X and end point value Y(i+1) of target variable Y in the future data by using difference model M.

By generating difference model M based on explanatory variable difference value ΔX and target variable difference value ΔY in each data section (i, i+1) in this manner, at least some of the uncertain factors included in the data can be canceled. Hence it is possible to derive difference model M in a state where the uncertain factors have been reduced. Thereby, a plurality of pieces of data can be analyzed with high accuracy.

A program according to the present exemplary embodiment is a program for causing a computer to execute the data analysis method described above.

By executing the program, a plurality of pieces of data can be analyzed with high accuracy.

### Second Exemplary Embodiment

[Configuration of Data Analysis Device]

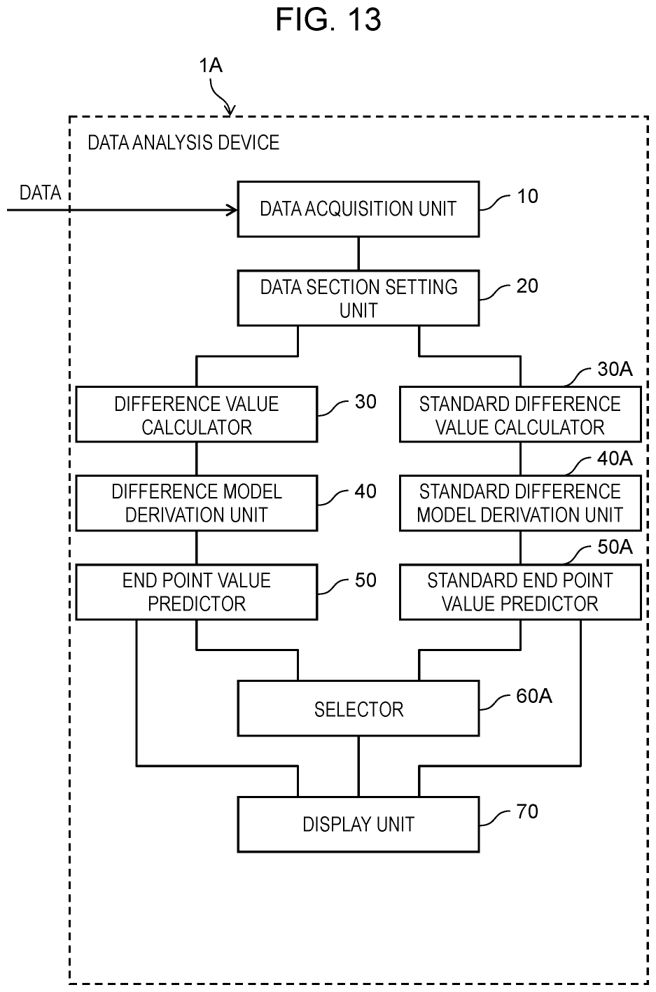

A configuration of data analysis device 1A according to a second exemplary embodiment will be described with reference to FIGS. 13 to 17. In the second exemplary embodiment, a description will be given of an example in which a start point value of a data section is replaced with a predetermined standard value to obtain a difference. Moreover, in the second exemplary embodiment, an example will be described in which an end point value obtained using the predetermined standard value is compared with the end point value obtained in the first exemplary embodiment to select a desired end point value. Note that the description of the same configuration as that of the first exemplary embodiment will be omitted or simplified.

FIG. 13 is a block diagram showing a functional configuration of data analysis device 1A according to the second exemplary embodiment.

As shown in FIG. 13, data analysis device 1A includes standard difference value calculator 30A, standard difference model derivation unit 40A, standard end point value predictor 50A, and selector 60A. Further, data analysis device 1A includes data acquisition unit 10, data section setting unit 20, difference value calculator 30, difference model derivation unit 40, end point value predictor 50, and output unit 104 described in the first exemplary embodiment.

Data acquisition unit 10 acquires a plurality of pieces of data by, for example, an operation input by a user who uses data analysis device 1A, a data input by an external device, or the like.

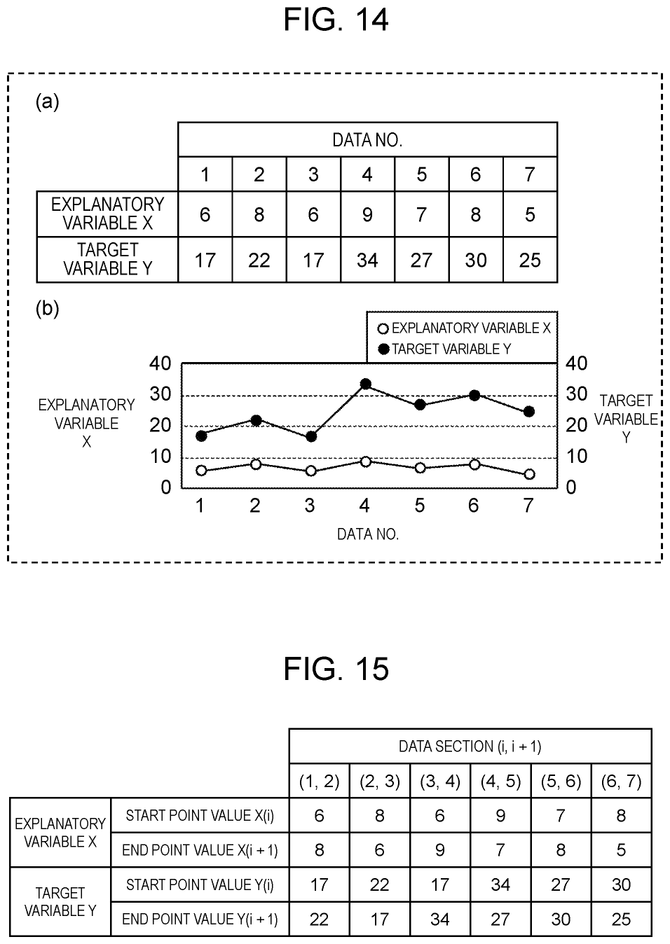

FIG. 14 is a diagram showing an example of a plurality of pieces of data acquired by data analysis device 1A. FIG. 14 shows a state where explanatory variable X and target variable Y included in each piece of data are organized in time series. Each piece of data includes an uncertain element that affects target variable Y, that is, an element that cannot be measured although affecting target variable Y.

Data section setting unit 20 sets a plurality of data sections for the plurality of pieces of data output from data acquisition unit 10.

FIG. 15 is a diagram showing an example of a plurality of data sections (i, i+1) set for a plurality of pieces of data. As shown in FIG. 15, in data section (i, i+1), ith data at a predetermined date and time is the start point value, and (i+1)th data at a date and time after the predetermined date and time is the end point value.

Standard difference value calculator 30A calculates a difference value related to explanatory variable X and a difference value related to target variable Y for each data section (i, i+1) set by data section setting unit 20. In the second exemplary embodiment, the start point value in data section (i, i+1) is taken as predetermined standard value Sx or Sy, and a difference value is calculated.

Specifically, standard difference value calculator 30A calculates explanatory variable difference value ΔX when standard value Sx is used, which is a difference between standard value Sx of explanatory variable X included in the ith data and end point value X(i+1) of explanatory variable X included in the (i+1)th data (ΔX=X(i+1)−Sx). Standard difference value calculator 30A calculates target variable difference value ΔY when standard value Sy is used, which is a difference between standard value Sy of target variable Y included in the ith data and end point value Y(i+1) of target variable Y included in the (i+1)th data (ΔY=Y(i+1)−Sy). Standard value Sx of explanatory variable X is the same in each data section (i, i+1) and is set to, for example, 7.5. Standard value Sy of target variable Y is also the same in each data section (i, i+1) and is set to, for example, 27.

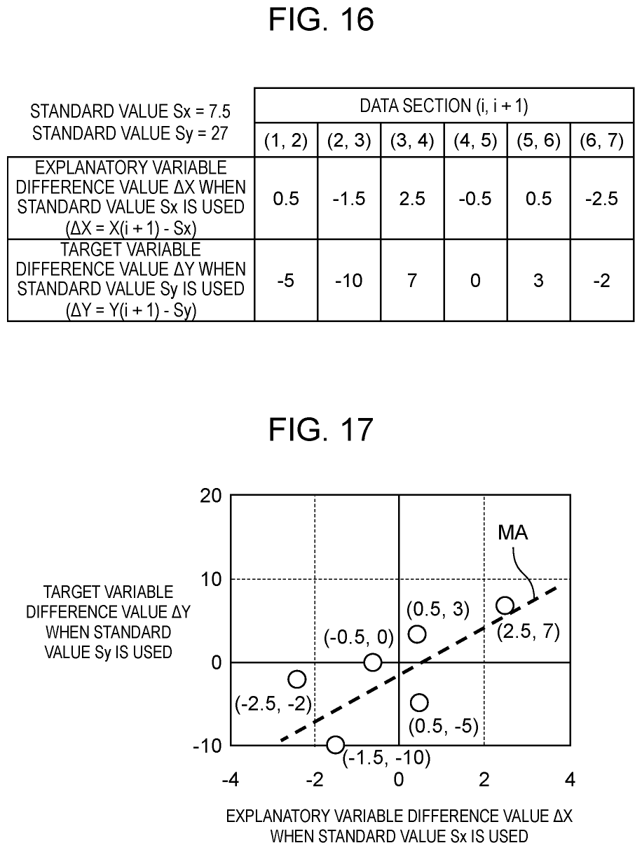

FIG. 16 is a diagram showing explanatory variable difference value ΔX and target variable difference value ΔY in each data section (i, i+1). For example, FIG. 15 shows that, in a data section (1, 2), explanatory variable difference value ΔX when standard value Sx is used is 0.5, and target variable difference value ΔY when standard value Sy is used is −5. The plurality of explanatory variable difference values ΔX and target variable difference value ΔY when the standard value is used, which have been calculated by standard difference value calculator 30A, are output to standard difference model derivation unit 40A.

Standard difference model derivation unit 40A derives standard difference model MA indicating a relationship between explanatory variable difference value ΔX and target variable difference value ΔY based on the plurality of explanatory variable difference values ΔX and target variable difference value ΔY when standard values Sx, Sy are used.

FIG. 17 is a diagram showing a relationship between explanatory variable difference value ΔX and target variable difference value ΔY in the second exemplary embodiment. In FIG. 17, a plurality of explanatory variable difference values ΔX and target variable difference values ΔY when standard values Sx, Sy are used are plotted. In FIG. 17, standard difference model MA indicating the relationship between the plurality of explanatory variable difference values ΔX and target variable difference value ΔY when standard values Sx, Sy are used is indicated by a thick broken line. The definition of standard difference model MA is the same as the definition of difference model M in the first exemplary embodiment. Standard difference model MA derived by standard difference model derivation unit 40A is stored into memory 103 and output to standard end point value predictor 50A.

Standard end point value predictor 50A predicts at least one of end point value X(i+1) of explanatory variable X and end point value Y(i+1) of target variable Y in the future data by using standard difference model MA. The method of obtaining end point value X(i+1) and end point value Y(i+1) of target variable Y is similar to that in the first exemplary embodiment.

Selector 60A compares difference d (not shown) between end point value Y(i+1) of target variable Y obtained by end point value predictor 50 and target value T of target variable Y with difference dA (not shown) between end point value Y(i+1) of target variable Y obtained by standard end point value predictor 50A and target value T of target variable Y. Then, selector 60A selects end point value Y(i+1) of target variable Y having a smaller difference between differences d and dA described above. Selector 60A selects end point value predictor 50 or standard end point value predictor 50A that has obtained end point value Y(i+1) of target variable Y having the smaller difference.

End point value predictor 50 or standard end point value predictor 50A selected by selector 60A predicts end point value X(i+1) of explanatory variable X based on end point value Y(i+1) of target variable Y selected by the selector 60A. End point value X(i+1) of explanatory variable X predicted by end point value predictor 50 or standard end point value predictor 50A is stored into memory 103 and output to output unit 104.

Output unit 104 displays end point value X(i+1) of explanatory variable X predicted by end point value predictor 50 or standard end point value predictor 50A. Output unit 104 displays end point value Y(i+1) of target variable Y predicted by end point value predictor 50 or standard end point value predictor 50A. Note that output unit 104 may display a plurality of pieces of data, data sections, standard values Sx, Sy, difference model M, standard difference model MA, and target value T.

Data analysis device 1A according to the second exemplary embodiment creates standard difference model MA based on the difference between standard value Sx of explanatory variable X and end point value X(i+1) and the difference between standard value Sy of target variable Y and end point value Y(i+1). By generating the model based on the difference between the standard value and the end point value in this manner, at least some of uncertainty factors included in the data can be canceled. Hence it is possible to derive standard difference model MA in a state where the uncertain factors have been reduced. As a result, it is possible to accurately analyze the plurality of pieces of data and predict at least one of end point value X(i+1) of explanatory variable X and end point value Y(i+1) of target variable Y in the future data.

### Example of Data Analysis Method

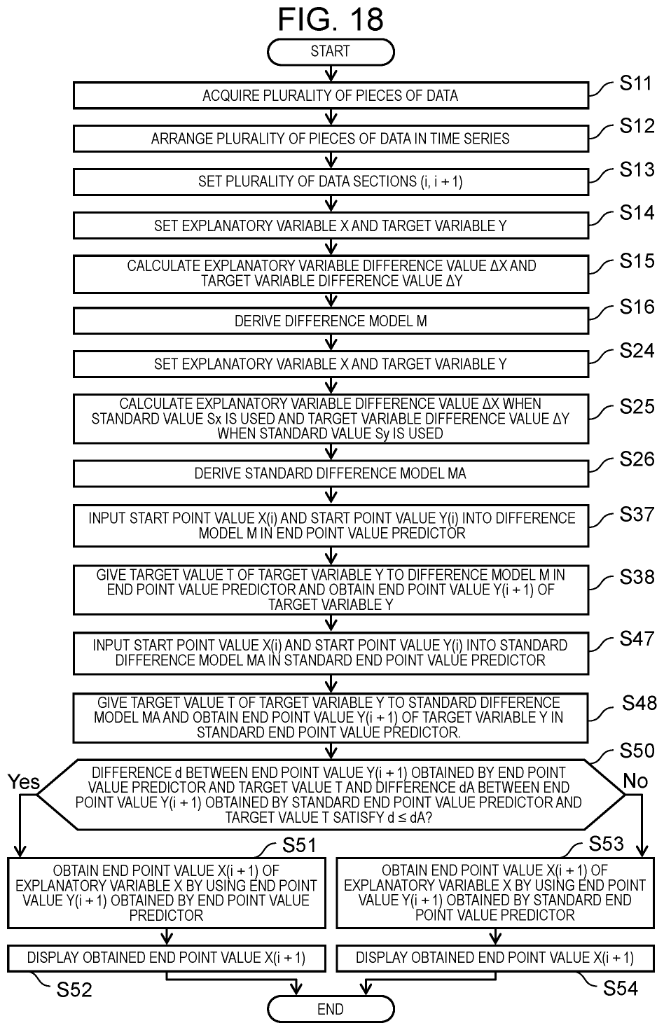

An example of a data analysis method according to the second exemplary embodiment will be described with reference to FIG. 18.

FIG. 18 is a flowchart showing an example of the data analysis method according to the second exemplary embodiment.

First, data acquisition unit 10 of data analysis device 1 included in data analysis device 1A acquires a plurality of pieces of data as shown in FIG. 6 (step S11).

Next, data section setting unit 20 organizes the plurality of pieces of data in time series (step S12). Then, data section setting unit 20 sets a plurality of data sections (i, i+1) as shown in FIG. 7 for the plurality of pieces of data organized in time series (step S13).

Next steps S14 to S16 are similar to those in the first exemplary embodiment. Note that steps S14 to S16 may be executed after steps S24 to S26 described below or may be executed simultaneously with steps S24 to S26.

In steps S24 to S26, first, standard difference value calculator 30A sets explanatory variable X and target variable Y for the plurality of pieces of data organized in step S12 (step S24). Next, in each data section (i, i+1), standard difference value calculator 30A calculates explanatory variable difference value ΔX when standard value Sx is used, which is a difference between standard value Sx of explanatory variable X and end point value X(i+1) of explanatory variable X included in the (i+1)th data. Standard difference value calculator 30A calculates target variable difference value ΔY when standard value Sy is used, which is a difference between standard value Sy of target variable Y and end point value Y(i+1) of target variable Y included in the (i+1)th data in each data section (i, i+1) (step S25. FIG. 16).

Next, standard difference model derivation unit 40A derives standard difference model MA indicating a relationship between explanatory variable difference value ΔX and target variable difference value ΔY based on the plurality of explanatory variable difference values ΔX and target variable difference value ΔY using standard values Sx, Sy (step S26). The definition of standard difference model MA is as described with reference to FIG. 9.

Through these steps S11 to S26, difference model M and standard difference model MA are generated. Hereinafter, a description will be given of an example of predicting end point value X(i+1) of explanatory variable X in the future data by using difference model M and standard difference model MA.

First, end point value predictor 50 inputs respective end point values X(i+1), Y(i+1) of explanatory variable X and target variable Y included in the past data into difference model M as respective start point values X(i), Y(i) of explanatory variable X and target variable Y in the future data (step S37). Then, end point value predictor 50 gives target value T of target variable Y in the future data to difference model M and obtains end point value Y(i+1) of target variable Y in the future data which is a value closet to target value T (step S38).

On the other hand, standard end point value predictor 50A inputs respective end point values X(i+1), Y(i+1) of explanatory variable X and target variable Y included in the past data into standard difference model MA as respective start point values X(i), Y(i) of explanatory variable X and target variable Y in the future data (step S47). Then, standard end point value predictor 50A gives target value T of target variable Y in the future data to standard difference model MA and obtains end point value Y(i+1) of target variable Y in the future data which is a value closet to target value T (step S48). Steps S47 and S48 may be executed before steps S37 and S38 or may be executed simultaneously with steps S37 and S38.

Next, selector 60A compares difference d between end point value Y(i+1) of target variable Y obtained by end point value predictor 50 and target value T of target variable Y with difference dA between end point value Y(i+1) of target variable Y obtained by standard end point value predictor 50A and target value T of target variable Y. Specifically, it is determined whether or not difference d is smaller than difference dA (step S50).

When difference d is smaller than difference dA (Yes in step S50), selector 60A obtains end point value X(i+1) of explanatory variable X by using end point value Y(i+1) of target variable Y obtained by end point value predictor 50 (step S51). Output unit 104 displays end point value X(i+1) of explanatory variable X obtained by end point value predictor 50 (step S52).

On the other hand, when difference d is larger than difference dA (No in step S50), selector 60A obtains end point value X(i+1) of explanatory variable X by using end point value Y(i+1) of target variable Y obtained by standard end point value predictor (step S53). Output unit 104 displays end point value X(i+1) of explanatory variable X obtained by standard end point value predictor 50A (step S54). By executing these steps S11 to S54, a plurality of pieces of data can be analyzed with high accuracy. [Another Example of Data Analysis Method]

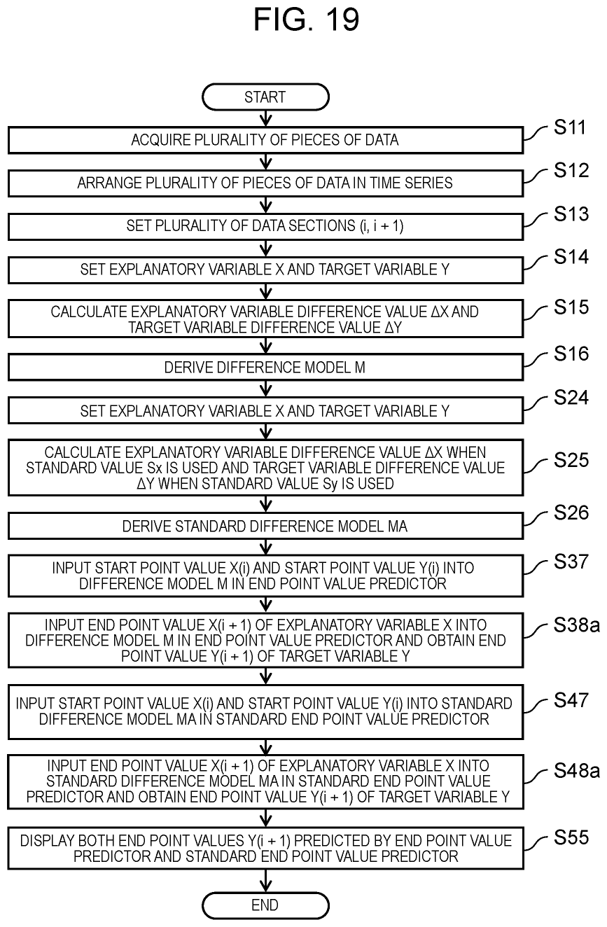

Another example of the data analysis method according to the second exemplary embodiment will be described with reference to FIG. 19. In another example, a description will be given of an example of predicting end point value Y(i+1) of target variable Y that is an output when end point value X(i+1) of predetermined explanatory variable X is input.

FIG. 19 is a flowchart showing another example of the data analysis method according to the second exemplary embodiment. Steps S11 to S26 are the same as the data analysis method shown in FIG. 18, and the description thereof will be omitted.

In this example, end point value predictor 50 inputs respective end point values X(i+1), Y(i+1) of explanatory variable X and target variable Y included in the past data into difference model M as respective start point values X(i), Y(i) of explanatory variable X and target variable Y in the future data (step S37). Then, end point value predictor 50 inputs end point value X(i+1) of explanatory variable X in the future data into difference model M to obtain end point value Y(i+1) of target variable Y in the future data (step S38a).

On the other hand, standard end point value predictor 50A inputs respective end point values X(i+1), Y(i+1) of explanatory variable X and target variable Y included in the past data into standard difference model MA as respective start point values X(i), Y(i) of explanatory variable X and target variable Y in the future data (step S47). Then, standard end point value predictor 50A inputs end point value X(i+1) of explanatory variable X in the future data into standard difference model MA to obtain end point value Y(i+1) of target variable Y in the future data (step S48a).

Output unit 104 displays end point values Y(i+1) of both target variable Y predicted by end point value predictor 50 and standard end point value predictor 50A (step S55). By executing these steps, a plurality of pieces of data can be analyzed with high accuracy.

### Effects and the Like

In addition to data analysis device 1, data analysis device 1A according to the present exemplary embodiment further includes standard difference value calculator 30A, standard difference model derivation unit 40A, and standard end point value predictor 50A. Standard difference value calculator 30A takes the start point values in data section (i, i+1) as predetermined standard values Sx, Sy, calculates explanatory variable difference value ΔX when standard value Sx is used, which is a difference between standard value Sx of explanatory variable X included in the ith data and end point value X(i+1) of explanatory variable X included in the (i+1)th data, and calculates target variable difference value ΔY when standard value Sy is used, which is a difference between standard value Sy of target variable Y included in the ith data and end point value Y(i+1) of target variable Y included in the (i+1)th data. Standard difference model derivation unit 40A derives standard difference model MA indicating a relationship between explanatory variable difference value ΔX and target variable difference value ΔY when standard values Sx, Sy are used, based on the plurality of explanatory variable difference values ΔX and target variable difference value ΔY when standard values Sx, Sy are used. Standard end point value predictor 50A predicts at least one of end point value X(i+1) of explanatory variable X and end point value Y(i+1) of target variable Y in the future data by using standard difference model MA.

By generating the model based on the difference between the standard value and the end point value in this manner, at least some of uncertainty factors included in the data can be canceled. Hence it is possible to derive standard difference model MA in a state where the uncertain factors have been reduced. As a result, it is possible to accurately analyze the plurality of pieces of data and accurately predict at least one of end point value X(i+1) of explanatory variable X and end point value Y(i+1) of target variable Y in the future data.

Data analysis device 1A may further include selector 60A that compares difference d between end point value Y(i+1) of target variable Y obtained by end point value predictor 50 and target value T of target variable Y with difference dA between end point value Y(i+1) of target variable Y obtained by standard end point value predictor 50A and target value T of target variable Y, and selects end point value Y(i+1) of target variable Y having a smaller difference.

According to this, end point value Y(i+1) of target variable Y in the future data can be predicted with higher accuracy.

In addition, selector 60A may select end point value predictor 50 or standard end point value predictor 50A that has obtained the end point value Y(Y+1) of target variable Y having the smaller difference, and end point value predictor 50 or standard end point value predictor 50A selected by selector 60A may predict end point value X(i+1) of explanatory variable X based on end point value Y(i+1) of target variable Y selected by selector 60A.

According to this, end point value X(i+1) of explanatory variable X in the future data can be predicted with higher accuracy.

### Other Exemplary Embodiments

Although the data analysis device and the like according to the present disclosure have been described above based on each of the exemplary embodiments, the present disclosure is not limited to these exemplary embodiments. Various modifications conceivable by those skilled in the art to the exemplary embodiments, as well as any forms constructed by combining some components in the exemplary embodiments, are also included in the scope of the present disclosure so long as not departing from the gist of the present disclosure.

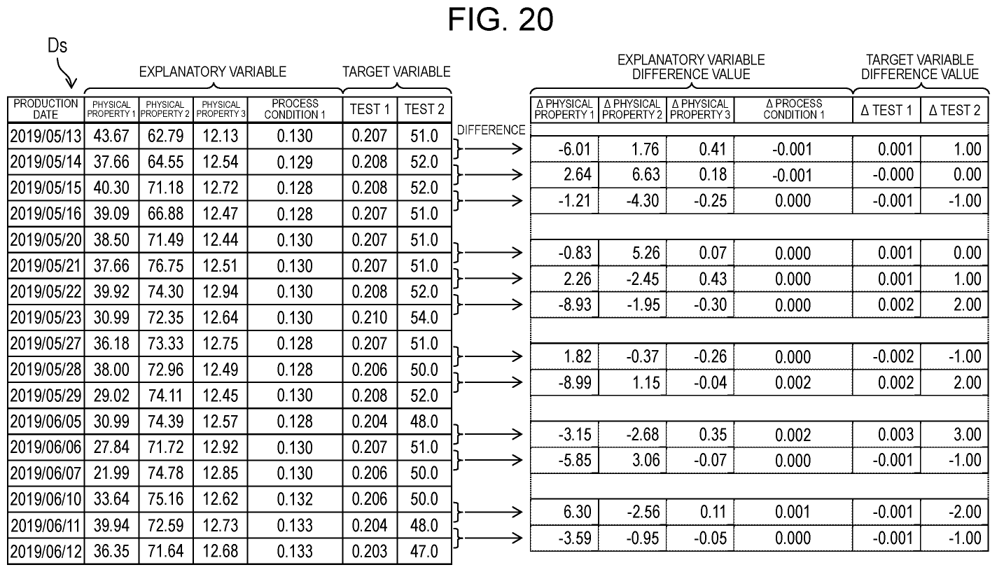

FIG. 20 shows an example in which an explanatory variable difference value and a target variable difference value are obtained with respect to data set Ds of FIG. 3. FIG. 20 shows a difference value between two variables of the same type having different production dates by one day. As another mode of the exemplary embodiment, as shown in FIG. 20, data analysis may be performed based on the explanatory variable difference value of each of physical property 1 to 3 and process condition 1 and the target variable difference value of each of test 1 and test 2.

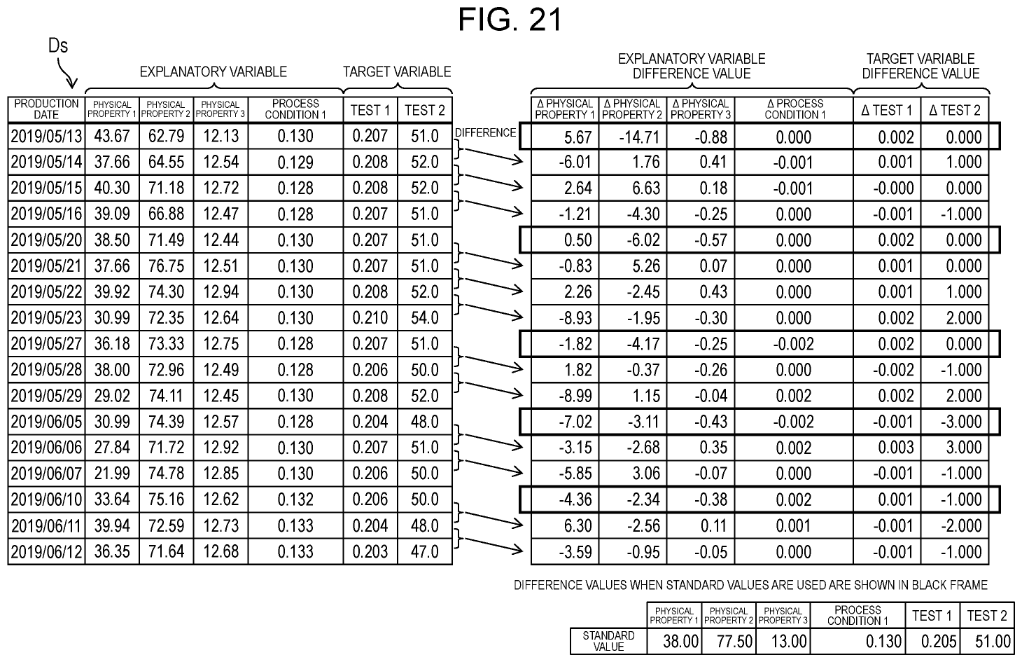

FIG. 21 shows an example in which an explanatory variable difference value and a target variable difference value are obtained using standard values with respect to data set Ds of FIG. 3. FIG. 21 shows an example in which the difference value is obtained using the standard value with respect to data for production having been started or resumed in data set Ds. As another mode of the exemplary embodiment, the data analysis may be performed including the explanatory variable difference value and the target variable difference value calculated using the standard values as shown in FIG. 21.

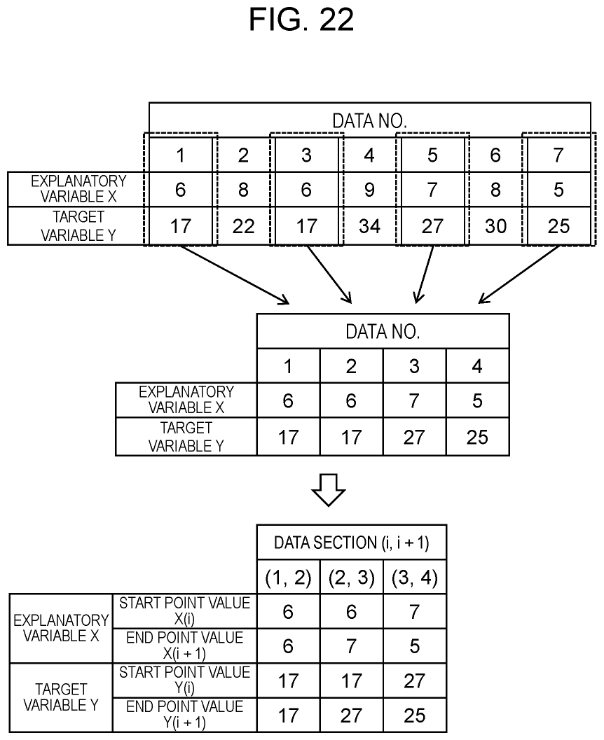

For example, in the first exemplary embodiment, data section setting unit 20 sets the data sections for the pieces of data arranged in time series, but the present invention is not limited thereto. Data section setting unit 20 may set data sections for pieces of data arranged in time series by skipping some pieces of data instead of following the order. FIG. 22 is a diagram showing another example of a plurality of data sections set for a plurality of pieces of data. FIG. 22 shows an example in which data sections are set by extracting data numbers 1, 3, 5, and 7 from the data shown in FIG. 2. In this case, the data numbers 1, 3, 5, and 7 may be arranged in time series and renumbered to data numbers 1, 2, 3, and 4, and each data section may be set such that two data sections adjacent in time series have common data. Specifically, end point value X(i+1) of explanatory variable X may be set to 6 in a data section (1, 2) after arrangement, and start point value X(i) of explanatory variable X may be set to 6 in a data section (2, 3).

Data section setting unit 20 may use averaged data, which is obtained after pieces of data arranged in time series are averaged in an arbitrary section. Data section setting unit 20 may use data after arithmetic processing, which is obtained after predetermined arithmetic processing is performed on pieces of data arranged in time series.

In the first exemplary embodiment, the end point value of the previous data is used as the start point value of the next data, but the end point value of the previous data may not necessarily be used as the start point value of the next data. For example, since there is no previous data in the first data acquisition, in this case, the standard value may be used as the start point value of the data. That is, as the data used at the time of generating difference model M, it is not necessary to use all pieces of data as actual input/output data, and difference model M may be generated by using the standard value for some pieces of data.

In the first exemplary embodiment, an example has been described in which the plurality of pieces of data includes one type of explanatory variable X and one type of target variable Y, but two or more types of explanatory variables may be used. For example, when there are two types of explanatory variables, difference model M may be derived using the explanatory variables as explanatory variable X₁ and explanatory variable X₂.

In the first exemplary embodiment, the example in which the plurality of pieces of data includes one type of target variable has been described. For example, when the plurality of pieces of data includes two or more types of target variables, the data analysis according to the present exemplary embodiment may be performed on each of the two or more types of target variables.

For example, the data analysis device may be specifically configured by a computer system including a microprocessor, a read-only memory (ROM), a random-access memory (RAM), a hard disk drive, a display unit, a keyboard, a mouse, and the like. A data analysis program is stored in the RAM or the hard disk drive. The microprocessor operates in accordance with the data analysis program, whereby the data analysis device achieves its function. Here, the data analysis program is configured by combining a plurality of command codes indicating instructions to the computer in order to achieve a predetermined function.

Further, some or all of the components constituting the data analysis device may be configured by one system large scale integration (LSI). The system LSI is a super multifunctional LSI manufactured by integrating a plurality of components on one chip and is specifically a computer system configured to include a microprocessor, a ROM, and a RAM. The RAM stores a computer program. The microprocessor operates in accordance with the computer program, whereby the system LSI achieves its function.

Furthermore, some or all of the components constituting the data analysis device may be configured by an integrated circuit (IC) card detachable from a computer or a single module. The IC card or the module is a computer system including a microprocessor, a ROM, a RAM, and the like. The IC card or the module may include the super multifunctional LSI described above. The microprocessor operates in accordance with the computer program, whereby the IC card or the module achieves its function. The IC card or the module may have tamper resistance.

The present disclosure may be a data analysis method executed by the data analysis device described above. The data analysis method may be realized by a computer executing a data analysis program or may be realized by a digital signal including a data analysis program.

Moreover, the present disclosure may include a non-transitory recording medium capable of reading a data analysis program or the digital signal in the computer Examples of the recording medium include a flexible disk, a hard disk, a CD-ROM, an MO, a DVD, a DVD-ROM, a DVD-RAM, a BD (Blu-ray (registered trademark) Disc), and a semiconductor memory. The data analysis program may include the digital signal recorded in a non-transitory recording medium.

Furthermore, the present disclosure may be configured by transmitting the data analysis program or the digital signal via a telecommunication line, a wireless or wired communication line, a network represented by the Internet, data broadcasting, or the like.

The present disclosure may be a computer system including a microprocessor and a memory. The memory stores a data analysis program, and the microprocessor operates in accordance with the data analysis program.

The present invention may be implemented by another independent computer system by recording the data analysis program or the digital signal on the non-transitory recording medium and transferring the data analysis program or the digital signal, or by transferring the data analysis program or the digital signal via the network or the like.

The data analysis system may include a server and a terminal possessed by a user connected to the server via a network.

According to the data analysis device and the like of the present disclosure, a plurality of pieces of data can be analyzed with high accuracy.

### INDUSTRIAL APPLICABILITY

The data analysis device of the present disclosure can be applied to data analysis such as prediction of a target variable with high accuracy. Further, the data analysis device of the present disclosure can predict and calculate a condition satisfying the target value of the target variable with high accuracy and can thus be applied to data analysis such as calculation and instruction of an optimal manufacturing condition by using data, for example. Moreover, the data analysis device of the present disclosure can be used for supporting manufacturing work, for example.

### REFERENCE MARKS IN THE DRAWINGS

1, 1A: data analysis device
10: data acquisition unit
20: data section setting unit
30: difference value calculator
30A: standard difference value calculator
40: difference model derivation unit
40A: standard difference model derivation unit
50: end point value predictor
50A: standard end point value predictor
60A: selector
101: input unit
102: arithmetic circuit
103: memory
104: output unit
105: storage
105a: program
105b: temporary data
106: database
107: communication unit
500: manufacturing management device
900: data analysis system
Ds: data set
d, dA: difference
M: difference model
MA: standard difference model
Sx, Sy: standard value
T: target value
X(i), Y(i): start point value
X(i+1), Y(i+1): end point value
X: explanatory variable
Y: target variable
ΔX: explanatory variable difference value
ΔY: target variable difference value
(i, i+1): data section

1. A data analysis device that analyzes a plurality of pieces of data including one or more types of explanatory variables and one type of target variable, the data analysis device comprising:
a data acquisition unit that acquires the plurality of pieces of data;
a difference value calculator that calculates an explanatory variable difference and a target variable difference in a data section, the data section being a section in which ith data at a predetermined date and time among the plurality of pieces of data is used as a start point value and (i+1)th data at a date and time after the predetermined date and time is used as an end point value, the explanatory variable difference value being a difference between the start point value of the explanatory variable included in the ith data and the end point value of the explanatory variable included in the (i+1)th data, the target variable difference value being a difference between the start point value of the target variable included in the ith data and the end point value of the target variable included in the (i+1) data, where i is an integer of one or more; and
a difference model derivation unit that derives a difference model indicating a relationship between the explanatory variable difference value and the target variable difference value based on a plurality of the explanatory variable difference values and a plurality of the target variable difference values.

2. The data analysis device according to claim 1, further comprising a data section setting unit that sets the data section in the plurality of pieces of data acquired by the data acquisition unit,
wherein the difference value calculator calculates the explanatory variable difference value and the target variable difference value for each of the data sections set by the data section setting unit.

3. The data analysis device according to claim 1, further comprising an end point value predictor that predicts at least one of the end point value of the explanatory variable and the end point value of the target variable in the data in a future by using the difference model.

4. The data analysis device according to claim 3, wherein the end point value predictor inputs the end point value of each of the explanatory variable and the target variable included in the data in a past into the difference model as the start point value of each of the explanatory variable and the target variable in the future data and gives a target value of the target variable in the future data to the difference model to obtain the end point value of the explanatory variable in the future data.

5. The data analysis device according to claim 4, wherein the end point value predictor obtains, in the difference model, the end point value of the explanatory variable in the future data when the end point value of the target variable in the future data is a value closest to the target value.

6. The data analysis device according to claim 3, wherein the end point value predictor inputs the end point value of each of the explanatory variable and the target variable included in the data in a past into the difference model as the start point value of each of the explanatory variable and the target variable in the future data and inputs the end point value of the explanatory variable in the future data into the difference model to obtain the end point value of the target variable in the future data.

7. The data analysis device according to claim 3, further comprising an output unit that displays at least one of the end point value of the explanatory variable and the end point value of the target variable in the future data.

8. The data analysis device according to claim 3, further comprising:
a standard difference value calculator that assumes the start point value in the data section as a predetermined standard value, calculates an explanatory variable difference value when the predetermined standard value is used, the explanatory variable difference value being a difference between the predetermined standard value of the explanatory variable included in the ith data and the end point value of the explanatory variable included in the (i+1)th data, and calculates a target variable difference value when the predetermined standard value is used, the target variable difference value being a difference between the predetermined standard value of the target variable included in the ith data and the end point value of the target variable included in the (i+1)th data;
a standard difference model derivation unit that derives a standard difference model indicating a relationship between the explanatory variable difference value and the target variable difference value when the predetermined standard value is used, based on the plurality of explanatory variable difference values and the target variable difference value when the predetermined standard value is used; and
a standard end point value predictor that predicts at least one of the end point value of the explanatory variable and the end point value of the target variable in the future data by using the standard difference model.

9. The data analysis device according to claim 8, further comprising a selector that compares a difference between the end point value of the target variable obtained by the end point value predictor and the target value of the target variable with a difference between the end point value of the target variable obtained by the standard end point value predictor and the target value of the target variable, and selects the end point value of the target variable having the difference being smaller.

10. The data analysis device according to claim 9, wherein
the selector selects the end point value predictor or the standard end point value predictor that obtains the end point value of the target variable having the difference being smaller, and
the end point value predictor or the standard end point value predictor selected by the selector predicts the end point value of the explanatory variable based on the end point value of the target variable selected by the selector.

11. A data analysis method for analyzing a plurality of pieces of data including one or more types of explanatory variables and one type of target variable, the data analysis method comprising:
acquiring the plurality of pieces of data;
calculating an explanatory variable difference and a target variable difference in a data section, the data section being a section in which ith data at a predetermined date and time among the plurality of pieces of data is used as a start point value and (i+1)th data at a date and time after the predetermined date and time is used as an end point value, the explanatory variable difference value being a difference between the start point value of the explanatory variable included in the ith data and the end point value of the explanatory variable included in the (i+1)th data, the target variable difference value being a difference between the start point value of the target variable included in the ith data and the end point value of the target variable included in the (i+1) data, where i is an integer of one or more;
deriving a difference model indicating a relationship between the explanatory variable difference value and the target variable difference value based on a plurality of the explanatory variable difference values and a plurality of the target variable difference values; and
predicting at least one of the end point value of the explanatory variable and the end point value of the target variable in the data in a future by using the difference model.

12. A program for causing a computer to execute the data analysis method according to claim 11.
